(19) United States
(12) Patent Application Publication
(10) Pub. No.: US 2013/0232400 A1
(43) Pub. Date: Sep. 5, 2013

(54) Dynamic Data Collection for Rule Based Documents

(71) Applicants: Brett Finnell, Monticello, MN (US); Taylor Olson, St. Cloud, MN (US); Ben Hales, Clear Lake, MN (US)

(72) Inventors: Brett Finnell, Monticello, MN (US); Taylor Olson, St. Cloud, MN (US); Ben Hales, Clear Lake, MN (US)

(21) Appl. No.: 13/409,884

(22) Filed: Mar. 1, 2012

(51) Int. Cl. G06F 17/00

(52) U.S. Cl. 715/224

(57) ABSTRACT

Methods, systems, and apparatuses, including computer programs encoded on computer-readable media, for receiving an ordered list of nodes that defines contents of a transaction document. The one or more nodes include a data field associated with one or more data items. Transaction data associated one or more data items is received. Each node of the ordered list of nodes is executed to generate a result tree that includes at least a portion of the transaction data. The result tree is sent to a remote device that displays a first document in a first format based upon the result tree. A second document is rendered in a second format based upon the result tree and sent to the remote device.

### BACKGROUND

Business transactions such as mortgages, loans, account creations, etc., require completing numerous documents. In addition to the number of documents, information is repeated through multiple documents. The number of documents required for a particular transaction can also increase based upon the collected information. For example, the state a person lives in can determine that state specific forms need to be completed for a particular transaction. Collecting and repeatedly inputting data into various forms can be time consuming and tedious.

### SUMMARY

In general, one aspect of the subject matter described in this specification can be embodied in methods for receiving an ordered list of nodes that defines contents of a transaction document. The one or more nodes include a data field associated with one or more data items. Transaction data associated one or more data items is received. Each node of the ordered list of nodes is executed to generate a result tree that includes at least a portion of the transaction data. The result tree is sent to a remote device that displays a first document in a first format based upon the result tree. A second document is rendered in a second format based upon the result tree and sent to the remote device. Other implementations of this aspect include corresponding systems, apparatuses, and computer-readable media configured to perform the actions of the method.

The details of one or more implementations of the subject matter described in this specification are set forth in the accompanying drawings and the description below, wherein like reference numbers and designations in the various drawings indicate like elements. Other features and aspects of the subject matter will become apparent from the description, the drawings, and the claims.

### BRIEF DESCRIPTION OF THE DRAWINGS

FIG. 1 is a block diagram of a document viewing system in accordance with an illustrative implementation.

FIG. 2 is a timing diagram for viewing a document in accordance with an illustrative implementation.

FIG. 3 is a timing diagram for collecting data and updating a document based upon the collected data in accordance with an illustrative implementation.

FIG. 4 is an example of a pop-up window for collecting multiple data items in accordance with an illustrative implementation.

FIG. 5 is a flow diagram for collecting data and updating a document based upon the collected data in accordance with an illustrative implementation.

FIG. 6 is a block diagram of a computer system in accordance with an illustrative implementation.

### DETAILED DESCRIPTION

According to various embodiments, a system and method is provided by which, users can provide data that is then used to populate data fields in multiple documents without having to reenter the same data multiple times. In addition, as data is collected the required documents for a particular transaction can be modified based upon the collected data. In one implementation, a description of a document can include rules that when executed modify the content of the document. These rules can be executed when the document is viewed. The execution of the rules determines the content of the document. Documents, therefore, are dynamic based upon the rules. In addition, when viewing a document, previously collected data can be integrated into the document. Data that is required by the document but has not yet been entered, can be collected using the document. For example, the document can include editable fields that are used to collect needed data from a user.

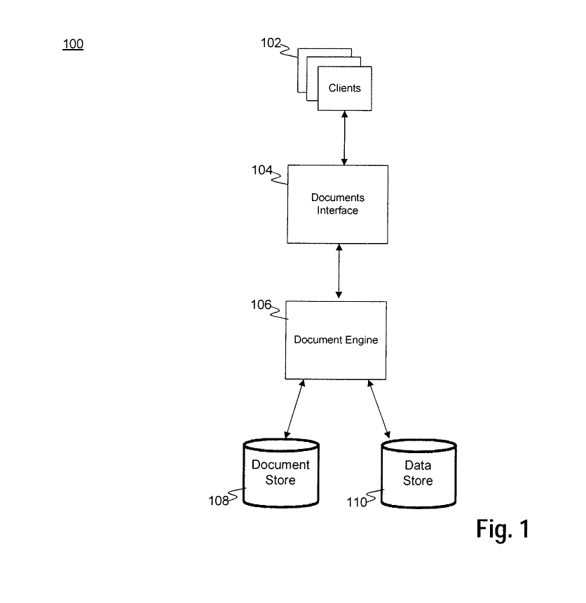

FIG. 1 is a block diagram of a document viewing system 100 in accordance with an illustrative implementation. The system includes one or more clients 102 that can view/edit/print documents from the system 100. Documents, e.g., the rules that define a document, can be stored in a document store 108. For example, a database, a file system, a data store, etc., can be used to store document rules. Data collected from a client 102 can be stored in a data store 110. The document store 108 and the data store 110 can be separate data stores or they can be a single data store. For example, the document rules can be stored in the same database as the data collected from the user.

As the document rules are stored in the document store 108, a document engine 106 is used to execute the rules and generate a document. The document rules can include various types of rules, some of which access data in the data store 110. As the document engine 106 is interpreting the document rules, data from the data store 110 can be accessed as needed. For example, when a document rule asks for some particular data, the document engine can first check if that data, e.g., user's home address, is in the data store 110. If the data is there, the document engine can retrieve and format the data appropriately for integrating into the document as is specified in the document rule. As an example, the data store 110 may store the user's home address as separate data items in the data store 110, e.g., the street address, city, state, zip code, etc., associated with the user's home address can be in different data items. The document engine can retrieve these data items and format the data, e.g., by concatenating the data appropriately, etc., and insert the formatted data into a document. A documents interface 104 can receive the document and transmit the document to a client 102. Data can be sent in the system 100, e.g., from/to the client 102, the documents interface 104, the document engine 106, the document store 108, the data store 110, etc., through known networks, e.g, WANs, LANs, WiFi, etc.

The documents interface 104 can also provide the client with a list of data items that are contained within the document as well as instructions on how data should be collected from the user. This information can also be sent to the client 102. The client 102 can use this information to construct user interface components to collect various data items from a user. The client can use the instructions to create data fields that allow the user to input needed data. A data field can include multiple data items. The documents interface 104 can provide a mapping of the data items that are contained in each data field. In addition to data fields, data items can be integrated into text components of the document that display the data items but do not allow the user to edit the data items. The mapping can also provide which data items are contained within the text components of the document. As described below, this mapping can be used to update a document when data items are changed.

In one implementation, the document viewing system 100 can be used to generate the needed documents for a particular transaction. For example, a user can first select a particular type of transaction from an interface, e.g., a mortgage transaction. Some initial data can be collected that is related to the transaction. As an example, the amount of the mortgage, the borrowers' names and addresses, the lender's name and address, etc., can be collected. This data can be stored in the data store 110. In response to a request from the client 102, the documents interface 104 and the document engine 106 can determine the various documents associated with the transaction based on the collected data and document select results that can be stored in the document store 108. As an example, one or more documents can be selected based upon the transaction being a mortgage. Another rule can select one or more documents based upon the lender, loan amount, borrower's address, etc. After the list of documents has been identified, the documents can be viewed, edited, used to collect data, converted to portable document format (PDF), printed, etc.

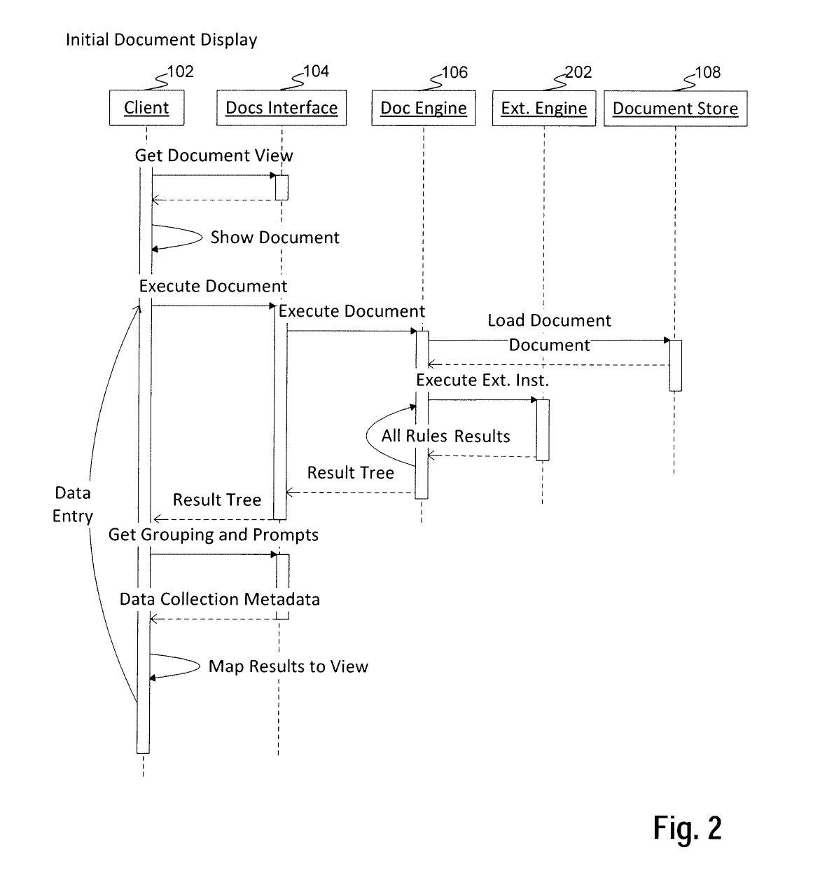

FIG. 2 is a timing diagram for viewing a document in accordance with an illustrative implementation. A client 102 can request a document from the documents interface 104. The documents interface 104 returns a blank static document. This document does not contain any conditional text, graphics, etc., based on user data nor does the document contain any user data. In one implementation, the document is converted into extensible markup language (XML) at or by the documents interface 104 and then sent to the client 102. The client 102 displays the document which in turn causes the document to be executed. To execute the document, the client 102 sends a request to the documents interface 104, which requests that the document be executed by the document engine 106. In one implementation, the client sends a document identifier and a transaction identifier to the documents interface 104. The document engine 106 requests the document from the document store 108, e.g., by using the document identifier. In one implementation, the document returned from the document store 108 describes a document using a tree structure. For example, the tree can include ordered nodes that define how a document is rendered. A node can describe text, rules, graphics, tables, etc., that are included in the document. The document engine 106 can then proceed to walk the tree, executing each rule within the tree. A result tree is generated from the execution of the rules and is returned to the client 102 through the documents interface 104.

Document rules can include boolean expressions, text formatting instructions, external instructions, etc. For example, a document may insert a conditional block of text based upon the dollar amount of a transaction. To insert the conditional text, a rule can include a boolean if statement that if the transaction amount is above a threshold the conditional text is inserted into the document, otherwise the text is not. In another example, a rule can concatenate various data items into a single field in a document. For example, address information stored in multiple data items can be concatenated together and then inserted into a paragraph of text. Rules can also include external instructions. External instructions are instructions that are not executed/interpreted by the document engine 106. For example, an external instruction can be an XPath expression used to select data. In this example, user data associated with a transaction can be retrieved from the data store 110. This data can be put into XML format and an XPath expression can be used to retrieve data from the XML format. When executing a rule that includes an external instruction, the document engine 106 can recognize an external instruction, for example by using a known external instruction prefix. Upon recognition, the document engine 106 can send the external instruction to an external engine 202, such as an XPath engine. The external engine 202 executes/interprets the received external instruction and returns the result to the document engine 106.

As the document engine 106 executes the rules associated with a document, the results are placed in a result tree. In one implementation, the result tree is an XML document and includes various nodes that are used to render the document as described in further detail below. The document can be rendered using a cascading style sheet that transforms the XML document into another viewable format, e.g., HTML. As the result tree is used to render the document at the client 102, the result tree includes data from the data store 110. In one implementation, each field that contains data from the data store 110 includes a pointer to the data that can be stored in another location in the result tree. Using these pointers, a list of data items that a portion of the document is dependent upon can be determined. In one implementation, a mapping of each data items to nodes in the result tree that depend upon the data item can be generated. As described in greater detail below, this mapping can be used to update a document when data associated with a data item changes.

In addition to viewing a document, the client 102 can be used to edit and/or collect data from a user. The data fields within the document may contain data from multiple data items. As an example, a user's first name, middle name, and last name can each be stored as a separate data item in a data store, e.g., the data store 110. A rendered document can include the user's full name, but show the name in a single data field. For example, a rendered document may have a single data field labeled name in which the user's name is shown as first name middle initial last name. A rule executed at the document engine 106 can retrieve the needed data and format the data as shown in the document. When the user edits the name data field within the document, the client 102 determines the various data items that are contained within the data field. For example, the mapping of data fields to data items can be used to determine that the name data field contains the first name, middle initial, and last name data items. As the user can provide/edit data for separate data items, the client 102 determines how the data associated with the data items are collected from the user. In one implementation, after receiving the result tree, the client 102 can request how various data items are grouped and the prompts used to collect data from the user. For example, this data can indicate that when the user edits the name data field that a pop-up window is displayed with three data fields corresponding to the first name, middle initial, and last name data items. The client 102 can then use the result tree along with the grouping and prompts to render the document for viewing and any additional user interface components needed to collect data.

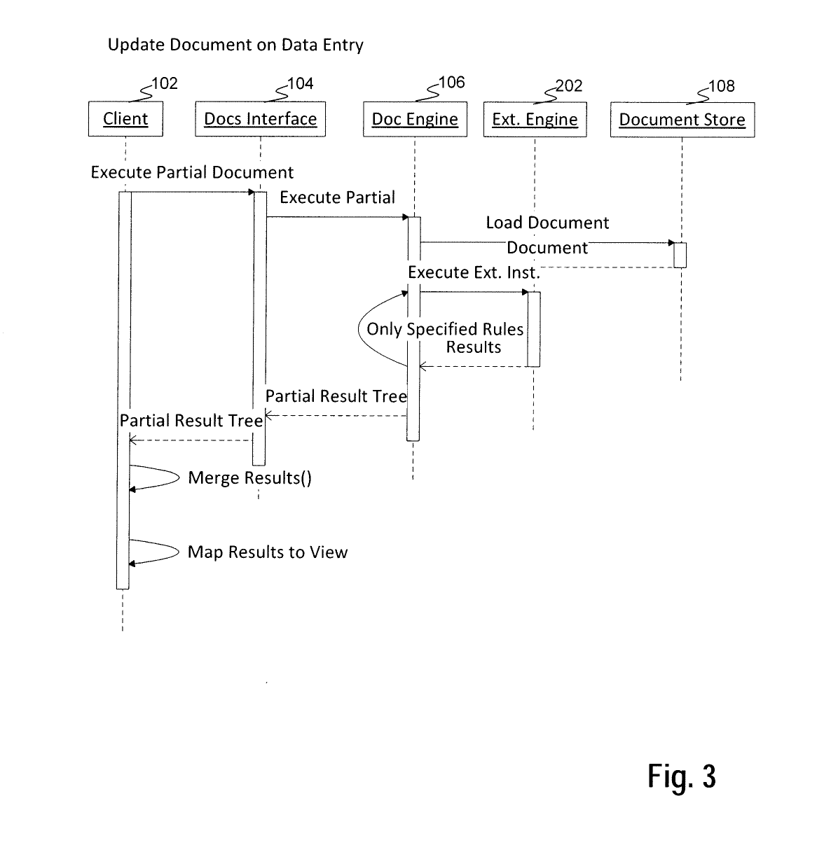

As described above, documents are generated based upon rules and these rules can depend upon data provided by a user. Documents can be used to collect the data from the user. The document, therefore, can change as the user enters data. FIG. 3 is a timing diagram for collecting data and updating a document based upon the collected data in accordance with an illustrative implementation. A document can include various data fields that can be used to describe how to collect data from a user, e.g., the type of prompts to use. Types of prompts for data fields can include text boxes, radio buttons, checkboxes, dropdown boxes, multi-selection boxes, text areas, etc. The data fields can map to a data item that is stored independently of other data in the data store 110. For example, the amount of a loan may be input in a document using a data field and may be stored in the data store 110 separate from any other data. To edit or add a loan amount, a user can select the data field and type in the loan amount. The client can then update the document based upon the updated loan amount. In one implementation, the updated data can be provided to the documents interface 104 and the entire document can be regenerated with the updated data.

In another implementation, only those portions of the document that depend upon the updated data are updated. In this implementation, the mapping of the data fields to the nodes in the result tree that depend upon the data field can be used. Continuing the above example, a document may include three data fields that depend upon the amount of a loan. One of the data fields can allow the user to add/modify the amount of the loan and two other data fields can simply render the amount of the loan in text. The document can also include numerous other nodes that do not depend upon the loan value. After the loan value is updated, the client 102 can determine the nodes that depend upon the loan value. The client 102 can use the mapping of each data field to nodes in the result tree as described above to determine the data fields that depend upon the loan value. Identifiers of these nodes can be sent to the documents interface 104. The document engine 106 can use these identifiers, received from the documents interface 104, to retrieve the corresponding rules from the document store 108. The document engine 106 can execute these rules in the same manner as described above in regard executing the entire document. The document engine 106 can then provide a partial result tree based upon the execution of the rules. The client 102 can merge the partial result tree, received from the documents interface 104, into the previously received result tree. The merged result tree can then be rendered to create the updated document. In the example above, the updated document will include the updated loan value in all three data fields that depend upon the loan value.

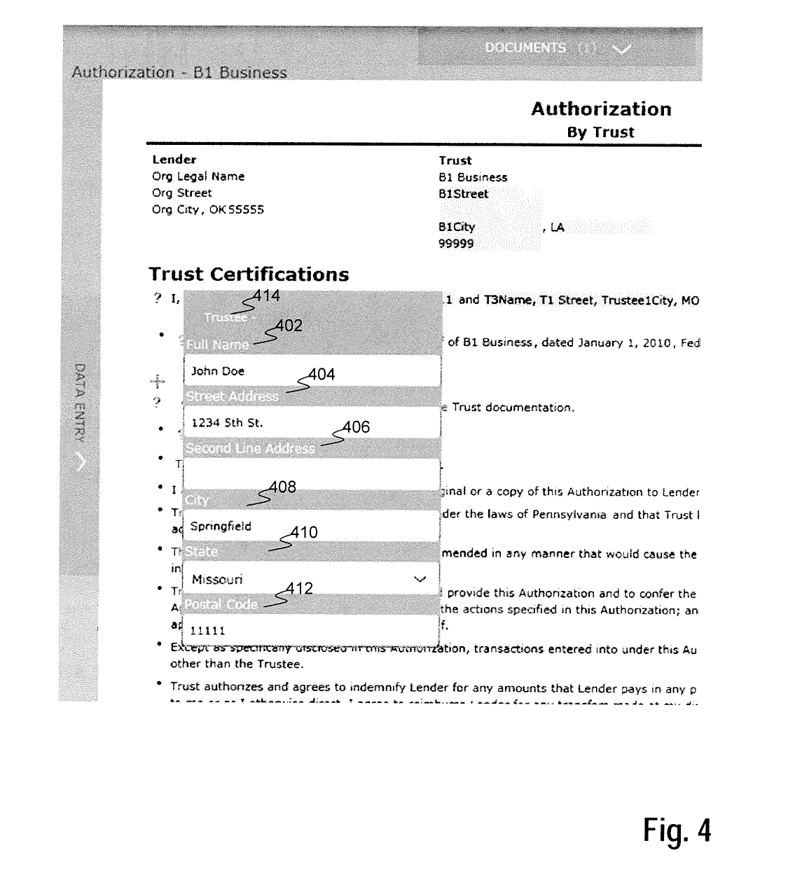

As described above, the loan value data field is mapped to a single item stored in the data store 110. A data field in a document, however, can be mapped to many different items in the data store 110. For example, a data field within a document can include a name and address of a person. Although displayed in the document as a single field, the name and address can be stored in different data items in the data store 110. The client 102 can still allow the user to change/add data. When a user selects the data field the client 102 can determine how data from the user can be collected. Using the grouping and prompts received from the documents interface 104, the client 102 can determine how the data is collected. FIG. 4 is an example of a pop-up window for collecting multiple data items in accordance with an illustrative implementation. In this example, the groups and prompt data can indicate the data should be collected in a pop up window that includes six different input fields: Full Name 402, Street Address 404, Second Line Address 406, City 408, State 410, and Postal Code 412. The data can also indicate which data items correspond with each input field. In addition, the data can include text data that is not associated with an input field. For example, label 414 indicates that the information is being collected in relation to a trustee. After the data is collected, the document can be updated as described above.

Documents can be rendered into various different formats. For example, documents can be rendered into markup languages, e.g., XML, HTML, SGML, etc. Documents can also be rendered into other formats such as, PDF, text, Microsoft Word, etc. For example, the documents interface 104 can request that a document be rendered in PDF format or in a format that allows collecting of data from a client. In one implementation, the result tree from the document engine 106 can be used to generate a PDF file that incorporates data previously collected and stored in the data store 110.

Documents stored in the document store 108 can be edited. For example, additional text, data fields, etc., can be added, modified, deleted, etc. from a document. Once a stored document has changed, the next time the document is rendered, the updated document in the document store 108 will be used to render the document. For example, data fields can be added to a document and/or prompts associated with data fields can be changed. The next time the document is rendered, the rendered document will include the added data field and changed prompts. Accordingly, a document can be changed once in the backend and the client 102 will see the updated document without requiring changes to the client. In addition, because various different formats of a document can be generated from the data stored in the document store 108, a document only needs to be updated a single time for the change to be reflected in the various different formats. For example, a document can be updated to collect additional information from a user. Once that change to the document has been stored in the document store 108, when the document is rendered, regardless of the format, the rendered document will include the changes to collect additional information from the user.

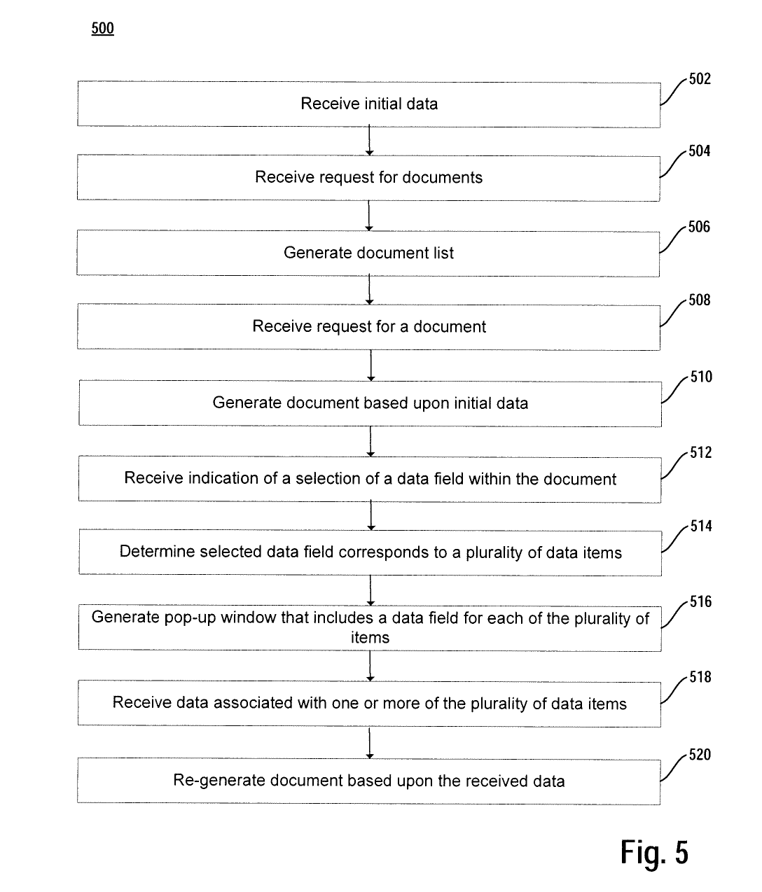

Various aspects of particular embodiments of the present invention have been described above. As another example, FIG. 5 is a flow diagram for collecting data and updating a document based upon the collected data in accordance with an illustrative implementation. The process 500 can be implemented on a computing device. In one implementation, the process 500 is encoded on a computer-readable medium that contains instructions that, when executed by a computing device, cause the computing device to perform operations of the process 500.

The process 500 includes receiving initial information (502). For example, a user can apply for a loan and the initial information includes the amount of the loan, name of the user, address of the user, and collateral information. In one implementation, the user can provide this data using a client 102. The client 102 can provide this data to the documents interface 104. After the initial information has been input, the client 102 can request a list of documents associated with a transaction, e.g, the loan. The documents interface 104 can receive this request for documents (504). Based upon this request, a list of documents associated with the transaction can be determined (506). In one implementation, the documents interface 104 can generate a list of documents associated with the transaction. In another implementation, the document engine 106 can generate the document list. In either implementation, rules can determine if a particular document is needed for a transaction. For example, certain documents may only be needed if the loan amount is above a certain value, if a down payment is less than a certain value, if the user lives in a particular state, etc.

The documents associated with the transaction can be viewed at the client 102. One or more documents can be requested from the system 100. In one implementation, the documents interface 104 can receive a request for a document (508). The documents interface 104 in conjunction with the document engine 106 can generate the document as described above using the initially provided data (510). The document can be sent to and displayed on the client 102. The document can allow for additional data to be collected at the client. In one implementation, various data fields can be selected at the client 102 and used to provide additional data. When a data field is selected, the client 102 can receive an indication of the selected data field within the document (512). The client 102 can then determine how data associated with the selected data field should be collected. As described above, some data fields may include data from multiple data items. The client 102 can determine if a selected data field includes multiple data items (514). Information provided by the documents interface 104 can be used in this determination. In one implementation, the client 102 can request a mapping of data fields to data items that are present in a document. This mapping can be used to determine that a selected data field maps to multiple data items. The mapping provided from the documents interface 104 can also include data that instructs the client 102 how the data items should be collected for a particular field. For example, the data can include instructions that the data should be collected in a pop-up and include data that defines the pop-up. The client 102 can generate a pop-up windows based upon this data (516).

The client 102 can then receive data from a user using the pop-up window. This data can be sent to the documents interface 104 (518). The data can be stored in the data store 110. After data has been entered, the document or portions of the document can be updated to reflect the newly added data (520). As described above, the mapping of data fields to data items can be used to determine all data fields within the document that may change based upon the updated data. The mapping can also include mappings of nodes that are not necessarily data fields to data items. For example, a paragraph of text may include a data item but not allow that data item to be edited within the paragraph. The mapping can include an indication that the paragraph may change when the data item is updated. The client 102 can request that the various nodes/data fields be executed to take into account the newly added data. In one implementation, the documents interface 104 provides a partial result tree that is merged with the initial result tree. The merged result tree is then used to re-render the document. This re-rendered document will be updated based upon the recently added data.

In addition to updating the document itself, the list of documents associated with a transaction can also change based upon entered data. For example, the documents interface 104 can determine if any documents should be added and if any previously added documents should be removed based upon the newly added data. The list of updated documents can be provided to the client 102, ensuring that the client 102 has an accurate list of documents for a particular transaction based upon the collected data.

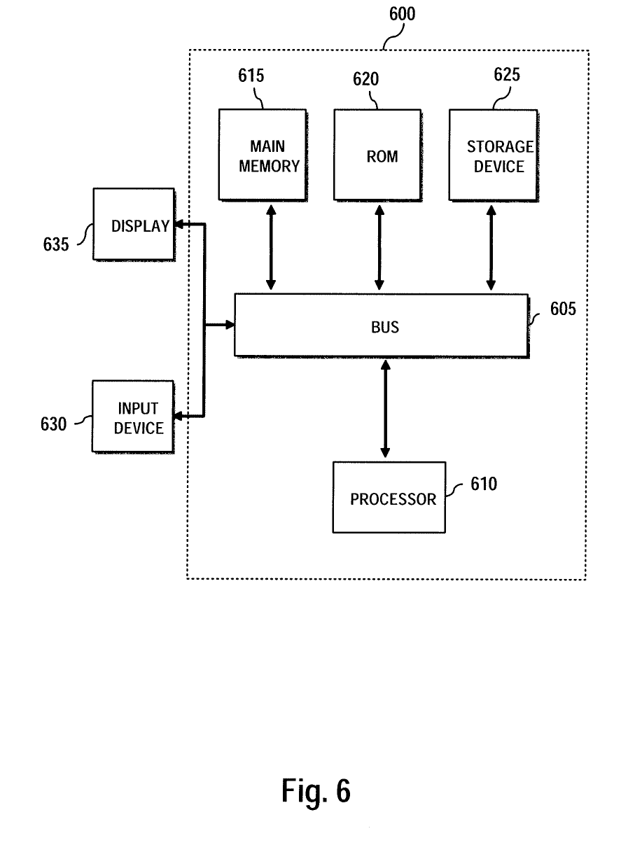

FIG. 6 is a block diagram of a computer system in accordance with an illustrative implementation. The computer system or computing device 600 can be used to implement the client 102, the documents interface 104, the document engine 106, etc. The computing system 600 includes a bus 605 or other communication component for communicating information and a processor 610 or processing circuit coupled to the bus 605 for processing information. The computing system 600 can also include one or more processors 610 or processing circuits coupled to the bus for processing information. The computing system 600 also includes main memory 615, such as a random access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a read only memory (ROM) 610 or other static storage device coupled to the bus 605 for storing static information and instructions for the processor 610. A storage device 625, such as a solid state device, magnetic disk or optical disk, is coupled to the bus 605 for persistently storing information and instructions.

The computing system 600 may be coupled via the bus 605 to a display 635, such as a liquid crystal display or active matrix display, for displaying information to a user. An input device 630, such as a keyboard including alphanumeric and other keys, may be coupled to the bus 605 for communicating information and command selections to the processor 610. In another implementation, the input device 630 has a touch screen display 635. The input device 630 can include a cursor control, such as a mouse, a trackball, or cursor direction keys, for communicating direction information and command selections to the processor 610 and for controlling cursor movement on the display 635.

According to various implementations, the processes described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative implementations, hard-wired circuitry may be used in place of or in combination with software instructions to effect illustrative implementations. Thus, implementations are not limited to any specific combination of hardware circuitry and software.

Although an example computing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” or “processing circuit” encompasses all kinds of apparatus, devices, and machines for processing data, including by way of example a programmable processor, a computer, a system on a chip, or multiple ones, or combinations of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving an ordered list of nodes that defines contents of a transaction document, wherein one or more nodes comprise a data field associated with one or more data items;
receiving transaction data associated one or more data items;
executing, using one or more processors, each node of the ordered list of nodes to generate a result tree, wherein the result tree comprises at least a portion of the transaction data;
sending the result tree to a remote device, wherein the remote device displays a first document in a first format based upon the result tree;
rendering a second document in a second format based upon the result tree; and
sending the second document to the remote device.

2. The method of claim 1, further comprising:
receiving a modification to the ordered list of nodes;
executing each node of the modified ordered list of nodes to generate a second result tree;
sending the second result tree to a remote device, wherein the remote device displays a modified first document in a first format based upon the second result tree;
rendering a modified second document in the second format based upon the second result tree; and
sending the modified second document to the remote device.

3. The method of claim 1, wherein the first format is a markup language and the second format is portable document format (PDF).

4. The method of claim 1, further comprising:
determining a set of documents associated with the transaction based upon the transaction data, wherein the set of documents includes the transaction document.

5. The method of claim 1, further comprising:
generating a mapping of data fields to data items; and
sending the mapping to the remote device.

6. The method of claim 5, further comprising:
receiving additional transaction data associated with one or more data items from the remote device;
receiving a request to execute a subset of the ordered list of nodes, wherein each node of the subset of the ordered list of nodes comprises one or more of the one or more data items associated with the additional transaction data, and wherein the subset of the ordered list of nodes is based upon the mapping of data fields to data items;
executing the subset of the ordered list of nodes to generate a partial result tree; and
sending the partial result tree to the remote device.

7. The method of claim 1, further comprising:
determining a set of documents associated with the transaction based upon the transaction data, wherein the set of documents includes the transaction document;
receiving additional transactions data associated with one or more data items from the remote device; and
revising the set of documents based upon the additional transaction data.

8. The method of claim 1, further comprising:
determining a data field including two or more data items;
generating instructions for collecting data associated with the two or more data items, wherein the instructions define a pop-up window; and
sending the instructions to the remote device.

9. The method of claim 8, wherein the instructions comprise a data field for each of the two or more data items.

10. A non-transitory computer-readable medium having instructions stored thereon that when executed by a computing device, cause the computing device to perform the method of claim 1.

11. A method comprising:
receiving initial transaction data associated with a transaction;
determining a set of one or more transaction documents associated with the transaction based upon the received initial transaction data;
receiving a request to render a first transaction document from a remote device in a first format;
receiving an ordered list of nodes that defines contents of the first transaction document, wherein one or more nodes comprise a data field associated with one or more data items;
executing, using one or more processors, each node of the ordered list of nodes to generate a result tree, wherein the result tree comprises at least a portion of the initial transaction data;
sending the result tree to a remote device, wherein the remote device displays the first transaction document in a first format based upon the result tree;
receiving a request to render the first transaction document from the remote device in a second format;
rendering the first transaction document in a second format based upon the result tree; and
sending the first transaction document in the second format to the remote device.

12. The method of claim 11, wherein the first format is a markup language and the second format is portable document format (PDF).

13. The method of claim 11, further comprising:
generating a mapping of data fields to data items; and
sending the mapping to the remote device.

14. The method of claim 13, further comprising:
receiving additional transaction data associated with one or more data items from the remote device;
receiving a request to execute a subset of the ordered list of nodes, wherein each node of the subset of the ordered list of nodes comprises one or more of the one or more data items associated with the additional transaction data, and wherein the subset of the ordered list of nodes is based upon the mapping of data fields to data items;
executing the subset of the ordered list of nodes to generate a partial result tree; and
sending the partial result tree to the remote device.

15. The method of claim 11, further comprising:
receiving additional transaction data associated with the transaction from the remote device; and
revising the set of one or more transactional documents based upon the additional transaction data.

16. The method of claim 11, further comprising:
determining a data field within the first transaction document includes two or more data items;
generating instructions for collecting data associated with the two or more data items, wherein the instructions define a pop-up window; and
sending the instructions to the remote device.

17. The method of claim 16, wherein the instructions comprise a data field for each of the two or more data items.

18. The method of claim 11, wherein executing one or more nodes comprises receiving results from executing external instructions, and wherein the result tree includes the results.

19. The method of claim 1, further comprising:
receiving a modification to the ordered list of nodes;
executing each node of the modified ordered list of nodes to generate a second result tree;
sending the second result tree to a remote device, wherein the remote device displays a modified first document in a first format based upon the second result tree;
rendering a modified second document in the second format based upon the second result tree; and
sending the modified second document to the remote device.

20. A non-transitory computer-readable medium having instructions stored thereon that when executed by a computing device, cause the computing device to perform the method of claim 11.
